(19) United States
(12) Patent Application Publication
(10) Pub. No.: US 2006/0148473 A1
(43) Pub. Date: Jul. 6, 2006

(54) Method for assigning an representing data to be used by a remote end

(75) Inventor: Ming-Yu Jiang, Tainan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/313,809

(22) Filed: Dec. 22, 2005

(30) Foreign Application Priority Data
Dec. 31, 2004 (TW) 093141681

(51) Int. Cl. H04Q 7/20; H04M 11/00

(52) U.S. Cl. 455/434; 455/403

(57) ABSTRACT

The present invention discloses a method for assigning an representing data to be used by a remote end, by which a near end can assign an representing data to a remote end through a telecommunication network so as to enable the remote end to recognize the near end. The method comprises the following steps: (A) transmitting a designated information to the remote end, the designated information including a identity of the near end and an index corresponding to the representing data; (B) checking whether the representing data with respect to the index is stored in the remote end; if so, executing step D; otherwise, executing step C; (C) downloading the representing data from the telecommunication network to the remote end; (D) checking whether the representing data is linked with the identity of the near end; if so, executing step F; otherwise, executing step E; (E) linking the representing data to the identity in the remote end; (F) prompting the remote end with the representing data for enabling the remote end to recognize the near end while the near end is alerting the remote end for building a linkage through the telecommunication network.

### FIELD OF THE INVENTION

The present invention relates to a method for assigning an representing data to be used by a remote end, and more particularly, to a method capable of enabling a near end to assign an representing data to a remote end through a telecommunication network so as to enable the remote end to recognize the near end.

### BACKGROUND OF THE INVENTION

Nowadays, telecommunication life style is becoming more and more common for people all over the world, by which most works can be accomplished by a few simple operation procedures. Consequently, a lot of errands can be done without even leaving home, but just by using one's handheld communication apparatus such as mobile phone.

While search a mobile phone of one's likings on the market, ringing tone is always one of the affecting factors. It is common for a user to extract a section of a preferred music and use the extracted music as the ringing tone of his mobile phone for distinguishing himself from others. Most users even acquire a habit of changing the ringing tone of his mobile phone on a regular basis.

Currently, ringing tones are mainly provided from three sources listed as following:
(1) Built-in ringing tones provided by the mobile phone manufacturers: most mobile phone on the market have a plurality of ringing tones built therein which are permanently resided in the mobile phone and will not be deleted by resetting the phone.
(2) User-edited musical files: a user can use a software provided by the mobile phone or other music editing software to create a melody and save the same usually in MIDI format so as to be used as his own ringing tone, which the sort of user-edited musical files can be edited or deleted at will.
(3) Ringing tines downloaded from system providers: a user can download a ringing tone from a system provider by short message service (SMS), which the sort of downloaded ringing tones can be edited or deleted at will.

It is noted that ringing tones can be linked with the phonebook of the mobile phone for enabling incoming calls of different caller to have different ringing tone. For instance, the melody extracted from “Fate Symphony” can be used for alerting an incoming call from a stranger, the melody extracted from “Pastoral Symphony” can be used for alerting an incoming call from a family member, and so on. It is even possible to assign a particular melody for a special person. Therefore, a mobile phone user can recognize a caller before answering an incoming call just by listening to the ringing tone and without having to check with the caller ID shown on the LCD of the mobile phone.

However, current technique of ringing tone management can only works on the ringing tone of the receiving end, that is, only the receiver can assign a ringing tone to an incoming call that the sender has no way of assigning a preferred melody to the receiving end as his identity alerting sound.

### SUMMARY OF THE INVENTION

It is the primary object of the invention to provide a method for assigning an representing data to be used by a remote end, by which a caller can assign an identity to be used in a receiver as his identity.

It is another object of the invention to provide a method for assigning an representing data to be used by a remote end, which is capable of enabling a receiver to use the representing data assigned by a caller while the receiver receive a call from the caller.

To achieve the above object, the present invention provide a method for assigning an representing data to be used by a remote end, by which a near end can assign an representing data to a remote end through a telecommunication network so as to enable the remote end to recognize the near end. The method comprises the following steps:
(A) transmitting a designated information to the remote end, the designated information including an identity of the near end and an index corresponding to the representing data;
(B) checking whether the representing data with respect to the index is stored in the remote end; if so, executing step D; otherwise, executing step C;
(C) downloading the representing data from the telecommunication network to the remote end;
(D) checking whether the representing data is linked with the identity of the near end; if so, executing step F; otherwise, executing step E;
(E) linking the representing data to the identity in the remote end; and
(F) prompting the remote end with the representing data for enabling the remote end to recognize the near end while the near end is alerting the remote end for building a connection through the telecommunication network.

### BRIEF DESCRIPTION OF THE DRAWINGS

FIG. 1 is the architecture of the present invention.

FIG. 2 is a flowchart of a first embodiment according to the present invention.

FIG. 3 is a flowchart of a second embodiment according to the present invention.

FIG. 4 is a flowchart of a third embodiment according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

The present invention is featuring in that: a caller (also addressed as the near end hereinafter) previously assigns an representing data to be recognized by a base station or a network server, and as the near end issue a call to a receiver (also addressed as the remote end hereinafter), the remote end can link the representing data to the near end so that the near end can assign the representing data to be used by the remote end for enabling the remote end to recognize the near end.

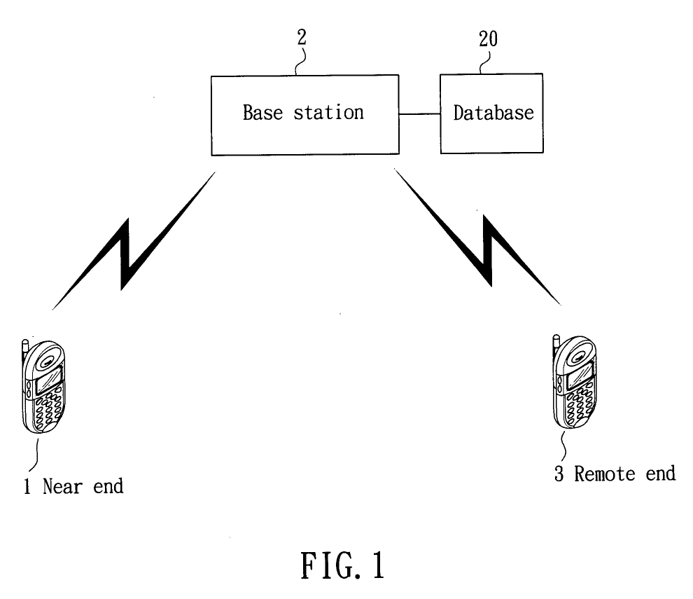

As the architecture shown in FIG. 1, the current communication network used by mobile phone is different from that of walkie talkie, in which a near end is connect to a remote end directly. As seen in FIG. 1, a signal issued by a near end 1 is received by a base station 2 and then the base station 2 redirect the signal to be received by a remote end 3, that is, the base station 2 builds connections respectively to the near end 1 and the remote end 3 so that the near end 1 is connect to a remote end 3 by way of the base station 2. By virtue of this, the near end 1 can assign and store an representing data in the database 20 of the base station 2, that the representing data can be either a ringing tone assigned by user of the near end, or can be a picture or an animation.

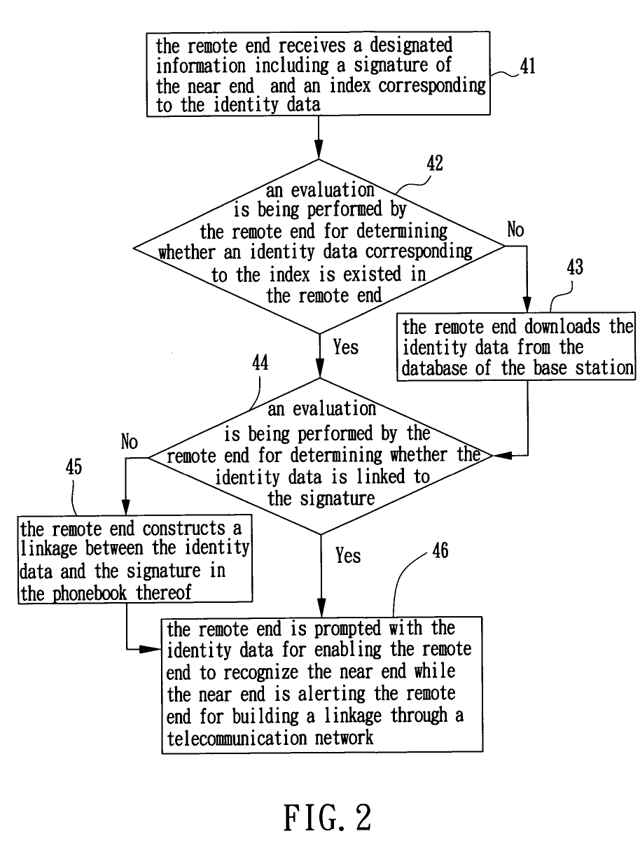

Please refer to FIG. 2, which is a flowchart of a first embodiment according to the present invention. The flowchart is initiated while a base station 2 is activated to link with a remote end 3 as a near end 1 is issuing a connection to the remote end 3 and the near end 1 is already linked with the base station 2. The flow starts from step 41. In the step 41, information transmitted from the base station 2 is received by the remote end 3, in which the information received by the remote end 3 includes a designated information comprising a identity of the near end 1 and an index, wherein the designated information can be defined by the near end 1, such as mobile phone or an Internet explorer interface, and is transmitted to the remote end 3 corresponding to the designated information by way of the base station 2 through a wireless network; and the index is point to one of the plural representing data stored in the database 20 of the base station 2 and the identity can be the phone number of the near end 1; and then the flow proceeds to step 42.

In the step 42, an evaluation is being performed by the remote end 3 for determining whether an representing data corresponding to the index is existed in the remote end 3; if so, the flow proceeds to step 44; otherwise, the flow proceeds to step 43.

In the step 43, the remote end downloads the representing data assigned by the near end 1 from the database 20 of the base station 2 while the representing data corresponding to the index is missing from the remote end 3, and then the flow proceeds to step 44.

In the step 44, an evaluation is being performed by the remote end 3 for determining whether the representing data is linked to the identity; if so, the flow proceeds to step 46; otherwise, the flow proceeds to step 45.

In the step 45, the remote end 3 constructs a linkage between the representing data and the identity in the phonebook thereof, that is, a linkage is construct in the phonebook of a mobile phone according to a preferred embodiment, or a linkage is construct in the phonebook of a subscriber identity module (SIM) card according to another preferred embodiment. The flow proceeds to step 46.

In step 46, the remote end 3 is prompted with the representing data of tone ringing or image displaying for enabling the remote end 3 to recognize the near end 1 while the near end 1 is alerting the remote end 3 for building a connection through a telecommunication network.

In a preferred embodiment, the near end 1 can actively issue a plurality of designated information to inform a plurality of remote end 3 corresponding thereto for initiating the step 41 of the abovementioned flowchart, such that the near end 1 is capable of simultaneously assigning an representing data to be used by the plural remote end 3.

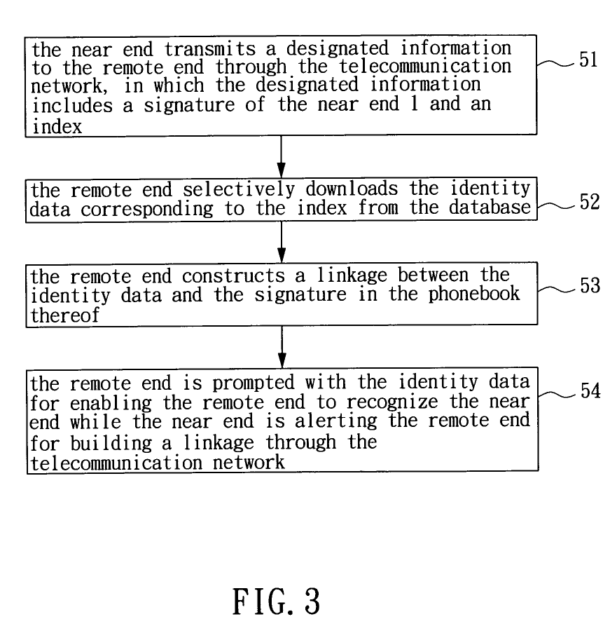

Please refer to FIG. 3, which is a flowchart of a second embodiment according to the present invention. It is noted that the present embodiment uses the same telecommunication network with database 20 storing a plurality of representing data therein as shown in FIG. 1. The flow starts from step 51. In the step 51, the near end 1 transmits a designated information to the remote end 3 through the telecommunication network, in which the designated information includes a identity of the near end 1 and an index corresponding to one of the representing data stored in the database 20 of the base station 2, and then the flow proceeds to step 52.

In the step 52, the remote end 3 selectively downloads the representing data corresponding to the index from the database 20, that is, the user of the remote end can either choose to download the representing data or not to download while the representing data is already existed in the remote end 3; the flow proceeds to step 53.

In the step 53, the remote end 3 constructs a linkage between the representing data and the identity in the phonebook thereof, and the flow proceeds to step 54.

In the step 54, the remote end 3 is prompted with the representing data for enabling the remote end 3 to recognize the near end 1 while the near end 1 is alerting the remote end 3 for building a linkage through a telecommunication network.

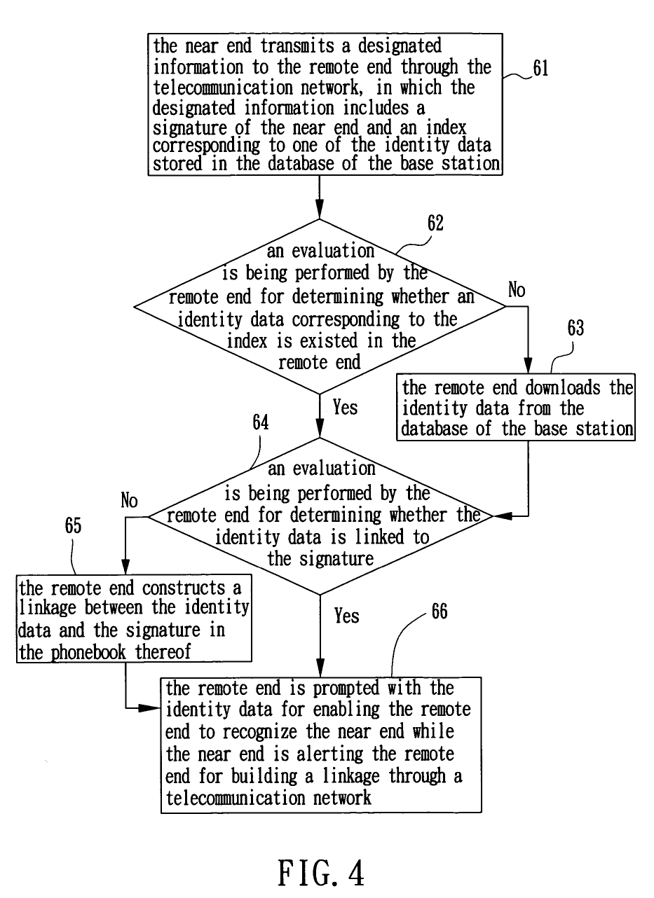

Similarly, in the present embodiment, the near end 1 can actively issue a plurality of designated information to inform a plurality of remote end 3 corresponding thereto for initiating the step 51 of the abovementioned flowchart, such that the near end 1 is capable of simultaneously assigning an representing data to be used by the plural remote end 3. The characteristics of the embodiment shown in FIG. 4 are that: the near end is capable of transmitting the representing data to the remote ends prescribed by the near end and the corresponding remote end is not required to check whether the representing data is existed therein or not.

Please refer to FIG. 4, which is a flowchart of a third embodiment according to the present invention. It is noted that the present embodiment uses the same telecommunication network with database 20 storing a plurality of representing data therein as shown in FIG. 1. In the present embodiment, the near end can assign an representing data to a remote end through a telecommunication network while the remote end is actively calling the near end through the telecommunication network. The flow starts from step 61. In the step 61, the near end 1 transmits a designated information to the remote end 3 through the telecommunication network while the remote end is building a linkage with the near end through the telecommunication network, in which the designated information includes a identity of the near end 1 and an index corresponding to one of the representing data stored in the database 20 of the base station 2, and then the flow proceeds to step 62.

In the step 62, an evaluation is being performed by the remote end 3 for determining whether an representing data corresponding to the index is existed in the remote end 3; if so, the flow proceeds to step 64; otherwise, the flow proceeds to step 63.

In the step 63, the remote end downloads the representing data assigned by the near end 1 from the database 20 of the base station 2, and then the flow proceeds to step 64.

In the step 64, an evaluation is being performed by the remote end 3 for determining whether the representing data is linked to the identity; if so, the flow proceeds to step 66; otherwise, the flow proceeds to step 65.

In the step 65, the remote end 3 constructs a linkage between the representing data and the identity in the phonebook thereof.

In the step 66, the remote end 3 is prompted with the representing data of tone ringing or image displaying for enabling the remote end 3 to recognize the near end 1 while the near end 1 is alerting the remote end 3 for building a linkage through a telecommunication network.

In a prior art disclosed in R.O.C. Pat. No. 535091, a method for downloading melody to a mobile phone through Internet is provided, which is similar to those commonly seen music download services. However, the melody downloaded by the abovementioned method can only be used as the ringing tone of a mobile phone and can not correlate with a caller for prompting the user of the mobile phone with the identity of the caller before answering the call.

Moreover, in another prior art disclosed in R.O.C. Pat. No. 410509, an apparatus and a method for prompting the identity of callers are disclosed, by which a user can previously record and link an audio file to a caller data resided in the Call ID file so as to prompt the user with the identity of the caller by playing the audio file. However, the abovementioned method still is not capable of enabling a near end to assign an representing data to a remote end.

In view of the above description, the present invention provides a method capable of enabling a near end to assign an representing data to a remote end, by which a user of a near end, as the caller, is able to assign a melody or animation with his own feature and style to be heard or displayed on a remote end, which is the receiver, for prompting the user of the remote end with his identity.

In addition, in the system providers' point of view, the method of the present invention can increase the download rate of ringing tone/animation so as to increase business since a ringing tone/animation selected by a user, as the caller, can be downloaded by every callee of the caller such that each time the ringing tone/animation is downloaded by a callee, a fee can be charged and pay by the caller.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for assigning a representing data to be used by a remote end, being adapted for a near end to assign the representing data to the remote end through a telecommunication network, the method comprising the steps of:
(A) transmitting a designated information to the remote end, the designated information including an identity of the near end and an index corresponding to the representing data;
(B) checking whether the representing data with respect to the index is stored in the remote end; if so, executing step D; otherwise, executing step C;
(C) downloading the representing data from the telecommunication network to the remote end;
(D) checking whether the representing data is linked with the identity of the near end; if so, executing step F; otherwise, executing step E;
(E) linking the representing data to the identity in the remote end; and
(F) prompting the remote end with the representing data for enabling the remote end to recognize the near end while the near end is alerting the remote end for building a linkage through the telecommunication network.

2. The method of claim 1, wherein the linking of the representing data to the identity in the remote end is accomplished in the phonebook of a mobile phone.

3. The method of claim 1, wherein the near end is capable of issuing a plurality of designated information to activate a plurality of remote end corresponding thereto for initiating an operation starting from the step A.

4. The method of claim 1, wherein the identity is the phone number of the near end.

5. The method of claim 1, wherein the representing data is a ringing tone and the prompting of the remote end with the representing data is by playing the ringing tone in the remote end.

6. The method of claim 1, wherein the representing data is an image and the prompting of the remote end with the representing data is by displaying the image on the display of the remote end.

7. The method of claim 1, wherein the representing data is an animation and the prompting of the remote end with the representing data is by displaying the animation on the display of the remote end.

8. A method for assigning a representing data to be used by a remote end, being adapted for a near end to assign the representing data to the remote end through a telecommunication network having a database with a plurality of representing data stored therein, the method comprising the steps of:
(A′) transmitting a designated information by the near end to the remote end through the telecommunication network, the designated information including an identity of the near end and an index;
(B′) performing by the remote end to selectively download the representing data corresponding to the index from the database;
(C′) performing by the remote end to construct a linkage between the representing data and the identity in the phonebook of the remote end; and
(D′) performing by the remote end to prompt the remote end with the representing data for enabling the remote end to recognize the near end while the near end is alerting the remote end for building a linkage through the telecommunication network.

9. A method for assigning an representing data to be used by a remote end, being adapted for a near end to assign the representing data to the remote end through a telecommunication network while the remote end is actively calling the near end through the telecommunication network, the method comprising the steps of:
(A″) performing by the near end to transmit a designated information to the remote end through the telecommunication network while the remote end is building a connection with the near end through the telecommunication network, the designated information including a identity of the near end and an index;
(B″) performing by the remote end to make an evaluation for determining whether the representing data corresponding to the index is existed in the remote end; if so, executing step D″; otherwise, executing step C″;
(C″) performing by the remote end to download the representing data from the telecommunication network;
(D″) performing by the remote end to make an evaluation for determining whether the representing data is linked to the identity; if so, executing step F″; otherwise, executing step E″;
(E″) performing by the remote end to construct a linkage between the representing data and the identity in the phonebook thereof;
(F″) prompting the remote end with the representing data for enabling the remote end to recognize the near end while the near end is alerting the remote end for building a linkage through the telecommunication network.

10. The method of claim 9, wherein the near end is capable of issuing a plurality of designated information to activate a plurality of remote end corresponding thereto for initiating an operation starting from the step A″.

11. The method of claim 9, wherein the representing data is a ringing tone and the prompting of the remote end with the representing data is by playing the ringing tone in the remote end.

12. The method of claim 9, wherein representing data is an image and the prompting of the remote end with the representing data is by displaying the image on the display of the remote end.

13. The method of claim 9, wherein the representing data is an animation and the prompting of the remote end with the representing data is by displaying the animation on the display of the remote end.

14. A method of assigning a representing data for a far end, the far end connecting a near end through a telecommunication network, the method comprising the steps of:
(A) transmitting a designated information to the remote end, the designated information including an identity of the near end and an index corresponding to the representing data;
(B) checking whether the representing data corresponding to the index is stored in the remote end, if so, executing step C;
(C) checking whether the representing data is linked with the identity of the near end; if so, executing step D;
(D) prompting the remote end with the representing data while the near end making a connection through the telecommunication network to the remote end.

15. The method of claim 14, wherein if the representing data corresponding to the index is not stored in the remote end, downloading the representing data from the telecommunication network to the remote end.

16. The method of claim 15, the telecommunication network further comprising a database which storing a plurality of representing data stored.

17. The method of claim 14, wherein if the representing data is not linked with the identity of the near end linking the representing data to the identity in the remote end.

18. The method of claim 14, wherein the representing data is a ringing tone and the prompting of the remote end with the representing data is by playing the ringing tone in the remote end.

19. The method of claim 14, wherein the representing data is an image and the prompting of the remote end with the representing data is by displaying the image on the display of the remote end.

20. The method of claim 14, wherein the representing data is an animation and the prompting of the remote end with the representing data is by displaying the animation on the display of the remote end.
